(19) United States
(12) Patent Application Publication
(10) Pub. No.: US 2025/0378095 A1
(43) Pub. Date: Dec. 11, 2025

(54) INFORMATION PROCESSING APPARATUS, DETERMINATION METHOD, AND COMPUTER-READABLE MEDIUM

(71) Applicant: NEC Corporation, Tokyo (JP)

(72) Inventor: Yousuke Motohashi, Tokyo (JP)

(73) Assignee: NEC Corporation, Tokyo (JP)

(21) Appl. No.: 19/224,971

(22) Filed: Jun. 2, 2025

(30) Foreign Application Priority Data
Jun. 7, 2024 (JP) 2024-093256

(51) Int. Cl. G06F 16/3329

(52) U.S. Cl. CPC G06F 16/33295

(57) ABSTRACT

An information processing apparatus includes at least one memory that stores instructions and at least one processor that executes the instructions. The at least one processor executes the instructions to: input a question sentence about a content of a targeted document to a language model generated by machine learning to generate an answer sentence to a question about the content of the document to cause the language model to generate a first answer sentence; and determine a similarity between a second answer sentence to the question sentence, the second answer sentence being generated by causing the language model to refer to at least a part of the document, and the first answer sentence.

### INCORPORATION BY REFERENCE

This application is based upon and claims the benefit of priority from Japanese patent application No. 2024-093256, filed on Jun. 7, 2024, the disclosure of which is incorporated herein in its entirety by reference.

### TECHNICAL FIELD

The present disclosure relates to an information processing apparatus, a determination method, and a computer-readable medium.

### BACKGROUND ART

A technique for adapting a language model generated by machine-learning a natural language to a specific domain is known. An example of a technique for adapting a language model to a specific domain is an information processing apparatus described in JP 2023-72863 A. This information processing apparatus extracts domain-specific words, which are expressions specific to the industry, by using sample data, and acquires sentences including the domain-specific words as data to be learned. Then, a new language model is constructed by machine-learning the domain specific words based on the acquired data to be learned. As a result, it is possible to construct a language model capable of accurately interpreting technical terms, industry-specific expressions, and the like.

### SUMMARY

The information processing apparatus described in JP 2023-72863 A has room for improvement in that the progress of the language model in learning cannot be automatically determined. If it is not possible to automatically determine the progress in learning, the amount and quality of data to be acquired and learned are insufficient, which may cause a problem that it is not possible to appropriately interpret the industry-specific expressions even though the newly constructed language model is used. In addition, there may be a problem that data to be learned is excessively acquired, which increases the cost of learning in addition to the cost of preparing the data to be learned. This is not limited to sentences including domain-specific words, and is a problem that occurs in common in a case where a certain document is learned by the language model.

The present disclosure has been made in view of such a problem, and an exemplary object thereof is to provide an information processing apparatus, a determination method, and a computer-readable medium capable of automatically determining the progress of a language model in learning a targeted document.

An information processing apparatus according to a first exemplary aspect of the present disclosure includes: a generation control unit for inputting a question sentence about a content of a targeted document to a language model generated by machine learning to generate an answer sentence to a question about the content of the document to cause the language model to generate a first answer sentence; and a determination unit for determining a similarity between a second answer sentence to the question sentence, the second answer sentence being generated by causing the language model to refer to at least a part of the document, and the first answer sentence.

A determination method according to a second exemplary aspect of the present disclosure includes: generation control processing in which at least one processor inputs a question sentence about a content of a targeted document to a language model generated by machine learning to generate an answer sentence to a question about the content of the document to cause the language model to generate a first answer sentence; and determination processing in which the at least one processor determines a similarity between a second answer sentence to the question sentence, the second answer sentence being generated by causing the language model to refer to at least a part of the document, and the first answer sentence.

A determination program according to a third exemplary aspect of the present disclosure causes a computer to function as: a generation control unit for inputting a question sentence about a content of a targeted document to a language model generated by machine learning to generate an answer sentence to a question about the content of the document to cause the language model to generate a first answer sentence; and a determination unit for determining a similarity between a second answer sentence to the question sentence, the second answer sentence being generated by causing the language model to refer to at least a part of the document, and the first answer sentence.

According to an exemplary aspect of the present disclosure, an exemplary effect is achieved in that it is possible to automatically determine the progress of a language model in learning a targeted document.

### BRIEF DESCRIPTION OF DRAWINGS

The above and other aspects, features and advantages of the present disclosure will become more apparent from the following description of certain exemplary embodiments with reference to the accompanying drawings, in which:

FIG. 1 is a block diagram illustrating a configuration of an information processing apparatus according to the present disclosure;

FIG. 2 is a flowchart illustrating a flow of a determination method according to the present disclosure;

FIG. 3 is a block diagram illustrating a configuration of another information processing apparatus according to the present disclosure;

FIG. 4 is a flowchart illustrating an example of processing executed by the information processing apparatus illustrated in FIG. 3;

FIG. 5 is a flowchart illustrating processing of S12 in FIG. 4 in detail; and

FIG. 6 is a block diagram illustrating a configuration of a computer that functions as an information processing apparatus according to the present disclosure.

### EXAMPLE EMBODIMENT

Hereinafter, example embodiments of the present disclosure will be described. However, the present disclosure is not limited to the example embodiments described below, and various modifications can be made within the scope set in the claims. For example, example embodiments obtained by appropriately combining the techniques (some or all of the products or methods) adopted in the following example embodiments can also be included in the scope of the present disclosure. In addition, example embodiments obtained by appropriately omitting some of the techniques adopted in the following example embodiments can also be included in the scope of the present disclosure. In addition, the effects mentioned in the following example embodiments are examples of effects expected in the example embodiments, and do not define the extension of the present disclosure. That is, example embodiments that do not achieve the effects mentioned in the following example embodiments can also be included in the scope of the present disclosure.

And each example embodiment can be appropriately combined with at least one of example embodiments.

### First Example Embodiment

A first example embodiment, which is an example of an example embodiment of the present disclosure, will be described in detail with reference to the drawings. The present example embodiment is a basic form for each example embodiment to be described below. Note that the application range of each technique adopted in the present example embodiment is not limited to the present example embodiment. That is, each technique adopted in the present example embodiment can also be adopted in other example embodiments included in the present disclosure as long as no particular technical problem occurs. Furthermore, each technique shown in the drawings referred to for describing the present example embodiment can also be adopted in other example embodiments included in the present disclosure as long as no particular technical problem occurs.

### Configuration of Information Processing Apparatus 1

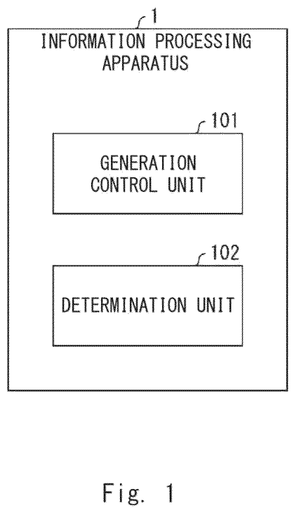

A configuration of an information processing apparatus 1 according to the present example embodiment will be described with reference to FIG. 1. FIG. 1 is a block diagram illustrating the configuration of the information processing apparatus 1. As illustrated in FIG. 1, the information processing apparatus 1 includes a generation control unit 101 and a determination unit 102.

The generation control unit 101 inputs a question sentence about a content of a targeted document to a language model generated by machine learning to generate an answer sentence to a question about the content of the document to cause the language model to generate a first answer sentence. Hereinafter, “a targeted document” will be referred to as “a target document”.

The target document is a document to be learned by the language model, and may include at least one sentence. For example, one or a plurality of sentences may be set as the target document, or some of the sentences (e.g. a chapter, a section, a paragraph) may be set as the target document. It can be said that the target document is a document indicating a domain to which the language model is to be adapted. For example, a product or service use manual may be used as the target document. By learning the use manual, it is possible to generate a language model capable of generating an answer sentence conforming to the use manual to a question sentence about a content of the product or service. Furthermore, for example, a document describing a measure against an occurrence of an injury or illness may be set as the target document. By learning such a document, it is possible to generate a language model capable of generating an answer sentence indicating an appropriate measure to a question sentence about a measure to be taken if an injury or illness occurs. In this manner, the information processing apparatus 1 can also be used for healthcare.

The language model may be any model generated by machine learning to generate an answer sentence to a question about a content of a target document. For example, a general-purpose language model obtained by machine-learning arrangements of components (words and the like) of sentences written in natural language or arrangements of texts in sentences may be updated by learning the target document for use as the language model. Such learning is called fine tuning. By fine-tuning the language model using training data in which answer sentences to question sentences according to the content of the target document are associated with the question sentences about the content of the target document, it is possible to generate a language model capable of generating an answer sentence conforming to the content of the target document to a question about the content of the target document. However, if the learning of the target document is insufficient, the generated answer sentence may not conform to the content of the target document.

The determination unit 102 determines a similarity between a second answer sentence to the question sentence, the second answer sentence being generated by causing the language model to refer to at least a part of the target document, and the first answer sentence generated by the generation control unit 101. Note that the similarity between the second answer sentence and the first answer sentence means a degree to which the contents of the first and second answer sentences are similar to each other. The same applies to the term “similarity” in the following description, which means a degree to which contents of sentences expressed in natural language are similar to each other.

Here, the wording “refer to at least a part of the target document” means that at least a part of the target document is given to the language model as reference information. For example, the second answer sentence may be generated by inputting a prompt including at least a part of the target document into the language model. Furthermore, for example, the second answer sentence may be generated by using a prompt including a link indicating a location where at least a part of the target document is stored. Note that, in a case where a part of the target document is referred to, the part is a part related to the question sentence in the target document, that is, a part that contains a statement that answers the question sentence.

In addition, the result of the determination of the similarity made by the determination unit 102 may indicate whether the first and second answer sentences are similar to each other, or may indicate a degree to which the first and second answer sentences are similar to each other. In addition, the similarity determination method is not particularly limited. For example, the determination unit 102 may determine the similarity between the first answer sentence and the second answer sentence using the above-described language model. Furthermore, for example, the determination unit 102 may convert the first answer sentence and the second answer sentence into respective vectors and calculate a similarity between the vectors. The determination of similarity using the language model will be described in a second example embodiment.

As described above, the information processing apparatus 1 according to the present example embodiment includes a generation control unit 101 that inputs a question sentence about a content of a target document to a language model generated by machine learning to generate an answer sentence to a question about the content of the target document to cause the language model to generate a first answer sentence; and a determination unit 102 that determines a similarity between a second answer sentence to the question sentence, the second answer sentence being generated by causing the language model to refer to at least a part of the target document, and the first answer sentence generated by the generation control unit 101.

Here, since the second answer sentence is generated with reference to at least a part of the target document, there is a high possibility that the second answer sentence is an appropriate answer sentence conforming to the content of the target document. On the other hand, since the first answer sentence is generated without referring to the target document, it is unclear whether the first answer sentence is an appropriate answer sentence conforming to the content of the target document. In particular, if a language model obtained by fine-tuning a general-purpose language model is used, there is a possibility that an answer sentence having a general content that is not related to the target document is generated.

Therefore, according to the above-described configuration, the similarity between the second answer sentence and the first answer sentence is determined. If the determination result of the determination unit 102 indicates that the first answer sentence and the second answer sentence are similar to each other, it can be said that there is a high possibility that the first answer sentence is an appropriate answer sentence conforming to the content of the target document. In this case, it can be said that the language model has learned the question sentence. On the other hand, if the determination result of the determination unit 102 indicates that the first answer sentence and the second answer sentence are not similar to each other, it can be said that there is a high possibility that the first answer sentence is not an appropriate answer sentence conforming to the content of the target document. In this case, it can be said that the language model has not learned the question sentence or has insufficiently learned the question sentence.

In this manner, the determination result of the determination unit 102 is an index for determining whether the targeted question sentence has been learned, unlearned, or insufficiently learned. Therefore, according to the information processing apparatus 1, it is possible to automatically determine the progress of the language model in learning the target document.

Furthermore, by automatically determining the progress of the language model in learning the target document, it is also possible to terminate the learning of the language model for the target document at an appropriate timing. Therefore, by using the information processing apparatus 1, it is possible to efficiently generate a language model optimized for generating an answer sentence for the target document.

### Determination Program

The above-described functions of the information processing apparatus 1 can also be realized by a program. A determination program according to the present example embodiment causes a computer to function as: a generation control means for inputting a question sentence about a content of a targeted document to a language model generated by machine learning to generate an answer sentence to a question about the content of the document to cause the language model to generate a first answer sentence; and a determination means for determining a similarity between a second answer sentence to the question sentence, the second answer sentence being generated by causing the language model to refer to at least a part of the document, and the first answer sentence. According to this determination program, it is possible to automatically determine the progress of the language model in learning the target document.

### Flow of Determination Method

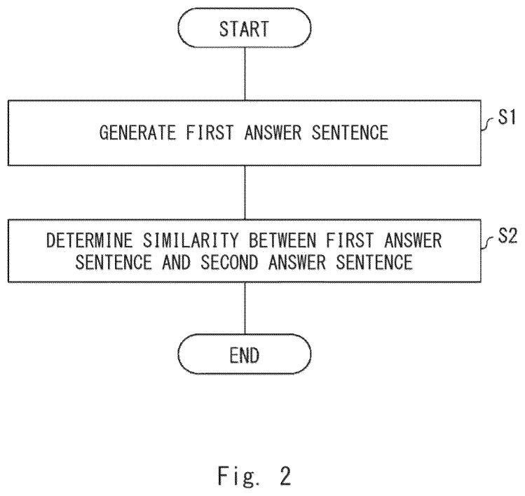

A flow of a determination method according to the present example embodiment will be described with reference to FIG. 2. FIG. 2 is a flowchart illustrating the flow of the determination method. Note that the entity that executes steps in this determination method may be a processor included in the information processing apparatus 1, may be a processor included in another apparatus, or may be a processor in which the entities that execute the steps are provided in different apparatuses.

In S1 (generation control processing), at least one processor inputs a question sentence about a content of a targeted document to a language model generated by machine learning to generate an answer sentence to a question about the content of the document to cause the language model to generate a first answer sentence.

In S2 (determination processing), at least one processor determines a similarity between a second answer sentence to the question sentence, the second answer sentence being generated by causing the language model to refer to at least a part of the document, and the first answer sentence generated in S1. The second answer sentence used in S2 may be one that has been generated in advance. The second answer sentence may be generated by any entity. For example, the at least one processor may also generate a second answer sentence before S2, and determine a similarity between the first answer sentence and the generated second answer sentence in S2.

As described above, the determination method performed by at least one processor according to the present example embodiment includes: generation control processing of inputting a question sentence about a content of a targeted document to a language model generated by machine learning to generate an answer sentence to a question about the content of the document to cause the language model to generate a first answer sentence; and determination processing of determining a similarity between a second answer sentence to the question sentence, the second answer sentence being generated by causing the language model to refer to at least a part of the document, and the first answer sentence. Therefore, according to the determination method according to the present example embodiment, it is possible to automatically determine the progress of the language model in learning the target document.

### Second Example Embodiment

A second example embodiment, which is an example of an example embodiment of the present disclosure, will be described in detail with reference to the drawings. Note that the application range of each technique adopted in the present example embodiment is not limited to the present example embodiment. That is, each technique adopted in the present example embodiment can also be adopted in other example embodiments included in the present disclosure as long as no particular technical problem occurs. Furthermore, each technique shown in each drawing referred to for describing the present example embodiment can also be adopted in other example embodiments included in the present disclosure as long as no particular technical problem occurs.

### Configuration of Information Processing Apparatus 1A

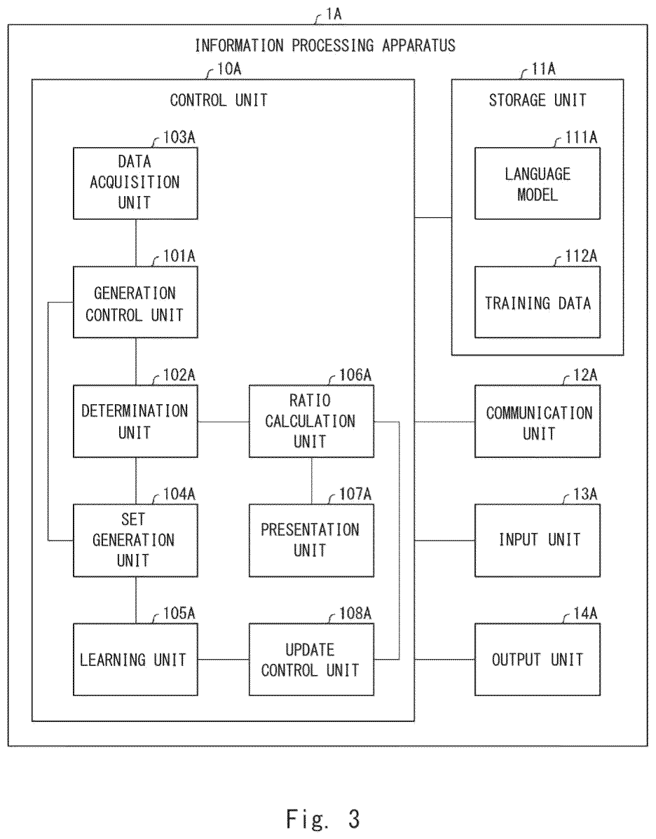

A configuration of an information processing apparatus 1A according to the present example embodiment will be described with reference to FIG. 3. FIG. 3 is a block diagram illustrating the configuration of the information processing apparatus 1A. The information processing apparatus 1A is an apparatus having a function of generating a language model suitable for generating an answer sentence for a targeted document (more precisely, updating the language model to increase accuracy in generating an answer sentence for the document). Note that the information processing apparatus 1A may be an apparatus whose main function is to update the language model, or may be a general-purpose apparatus having other functions. Furthermore, the information processing apparatus 1A may be a stationary apparatus or a portable apparatus.

As illustrated in FIG. 3, the information processing apparatus 1A includes a control unit 10A that integrally controls each unit of the information processing apparatus 1A, and a storage unit 11A that stores various types of data used by the information processing apparatus 1A. Furthermore, the information processing apparatus 1A includes a communication unit 12A for the information processing apparatus 1A to communicate with other apparatuses, an input unit 13A that receives an input to the information processing apparatus 1A, and an output unit 14A for the information processing apparatus 1A to output data. Then, the control unit 10A includes a data acquisition unit 103A, a generation control unit 101A, a determination unit 102A, a set generation unit 104A, a learning unit 105A, a ratio calculation unit 106A, a presentation unit 107A, and an update control unit 108A. In addition, the storage unit 11A stores a language model 111A and training data 112A. Note that the ratio calculation unit 106A will be described later in sections “regarding dissimilarity ratio/similarity ratio between first answer sentence and second answer sentence” and “regarding dissimilarity ratio/similarity ratio between first answer sentence and third answer sentence”.

The data acquisition unit 103A acquires a document to be learned by the language model 111A (referred to as a target document as in the first example embodiment). As in the first example embodiment, the target document is a document whose content is to be learned by the language model 111A, and may include at least one sentence.

The generation control unit 101A performs control to cause the language model 111A to generate various sentences. More specifically, the generation control unit 101A causes the language model 111A to generate a sentence by inputting a prompt instructing the language model 111A to generate a sentence to the language model 111A. Note that the language model 111A stored in an apparatus outside the information processing apparatus 1A may be used. In this case, the generation control unit 101A transmits a prompt to an external apparatus to generate a sentence, and acquires the generated sentence from the external apparatus.

For example, the generation control unit 101A can cause the language model 111A to generate a question sentence about the content of the target document. In this case, the generation control unit 101A may generate a question sentence by generating a prompt including the target document and instructing the language model 111A to generate a question sentence about the content of the target document, and inputting the generated prompt to the language model 111A. Furthermore, the generation control unit 101A may repeatedly generate a question sentence to obtain a set of questions covering the entire target document.

Furthermore, for example, the generation control unit 101A can cause the language model 111A to refer to at least a part of the target document to generate a second answer sentence to the question sentence. In this case, the generation control unit 101A may generate a prompt including the question sentence and a part or all of the target document and instructing the language model 111A to generate an answer sentence based on the content of the target document, and input the generated prompt to the language model 111A to generate a second answer sentence. In a case where a plurality of question sentences are generated, the generation control unit 101A generates a second answer sentence for each question sentence. The pair of the question sentence and the second answer sentence to the question sentence generated in this way is training data for updating the language model 111A so that an answer sentence conforming to the content of the target document can be generated.

Furthermore, for example, the generation control unit 101A can input a question sentence about the content of the target document to the language model 111A to cause the language model 111A to generate a first answer sentence. In this case, the generation control unit 101A may generate the first answer sentence by generating a prompt including the question sentence and instructing the language model 111A to generate an answer sentence to the question sentence, and inputting the generated prompt to the language model 111A. In a case where a plurality of question sentences are generated, the generation control unit 101A generates a first answer sentence for each question sentence.

Similarly to the language model described in the first example embodiment, the language model 111A is a language model generated by machine learning to generate an answer sentence to a question about the content of the target document. As described above, the language model 111A can also be used to generate a question sentence about the content of the target document, and can also be used to determine a similarity between sentences.

The determination unit 102A determines a similarity between sentences. In the present example embodiment, an example in which the determination unit 102A determines the similarity using the language model 111A will be described, but the similarity determination method is arbitrary and is not limited to this example. Furthermore, the determination unit 102A may determine the similarity using a language model different from the language model 111A.

Similarly to the determination unit 102 included in the information processing apparatus 1 of the first example embodiment, the determination unit 102A determines a similarity between the first answer sentence and the second answer sentence to the question sentence about the content of the target document. As described above, the first answer sentence is an answer sentence generated by inputting the question sentence to the language model 111A, and the second answer sentence is an answer sentence to the same question sentence as the first answer sentence, the second answer sentence being generated by causing the language model 111A to refer to at least a part of the target document.

In addition, as will be described in detail later, the determination unit 102A also determines a similarity between the first answer sentence and a third answer sentence to be described later. Furthermore, the determination unit 102A also determines a similarity between a plurality of question sentences for the content of the target document generated by the language model 111A as targets.

The set generation unit 104A generates a question sentence set including a plurality of question sentences generated by the language model 111A based on the result of the determination of the similarity between the plurality of question sentences by the determination unit 102A. Each question sentence included in the set generated by the set generation unit 104A is stored in association with the above-described second answer sentence in the storage unit 11A as the training data 112A. In this manner, the information processing apparatus 1A also has a function of generating the training data 112A.

The learning unit 105A updates the language model 111A by machine learning using the training data 112A. As described above, the training data 112A is obtained by associating the second answer sentence (the answer sentence generated by causing the language model 111A to refer to at least a part of the target document) with the question sentence about the content of the target document.

The presentation unit 107A presents various types of information to a user of the information processing apparatus 1A. The user of the information processing apparatus 1A is, for example, an operator who manages the update of the language model 111A. An aspect of the presentation is not particularly limited. For example, the presentation unit 107A may present information by audio output, by display output, or by print output. In addition, information is presented by any apparatus. For example, the presentation unit 107A may cause the output unit 14A to present information. Furthermore, for example, the presentation unit 107A may cause a terminal apparatus or the like possessed by the user to present information by communication via the communication unit 12A.

The update control unit 108A controls the update of the language model 111A. More specifically, the update control unit 108A determines whether to terminate the update after the language model 111A is updated by the learning unit 105A, and causes the learning unit 105A to update the language model 111A if it is determined not to terminate the update (that is, it is determined to continue the update). The update control unit 108A repeats such processing until it is determined to terminate the update. As a result, the language model 111A capable of generating answer sentences conforming to the content of the target document in response to various question sentences about the target document is generated.

As described above, the information processing apparatus 1A includes a generation control unit 101A that inputs a question sentence about a content of a target document to a language model 111A generated by machine learning to generate an answer sentence to a question about the content of the target document to cause the language model 111A to cause the language model 111A to generate a first answer sentence; and a determination unit 102A that determines a similarity between a second answer sentence to the question sentence, the second answer sentence being generated by causing the language model 111A to refer to at least a part of the target document, and the first answer sentence. Therefore, similarly to the information processing apparatus 1, it is possible to automatically determine the progress of learning of the language model for the target document.

### Regarding Dissimilarity Ratio/Similarity Ratio Between First Answer Sentence and Second Answer Sentence

As described above, the generation control unit 101A may cause the language model 111A to generate a first answer sentence and a second answer sentence for each of the plurality of question sentences. Furthermore, in this case, the determination unit 102A may determine a similarity for each pair of the first answer sentence and the second answer sentence corresponding to the same question sentence.

Then, in this case, the ratio calculation unit 106A may calculate a dissimilarity ratio, which is a ratio of pairs each including a first answer sentence and a second answer sentence whose contents are dissimilar to each other with respect to all of the plurality of pairs of first answer sentences and second answer sentences, based on the result of the determination of the similarity for each pair including a first answer sentence and a second answer sentence corresponding to the same question sentence.

The dissimilarity ratio calculated in this manner indicates a ratio of question sentences to which the first answer sentences do not conform to the content of the target document with respect to all the plurality of question sentences, and is an index indicating a degree of progress in learning the plurality of targeted question sentences. Specifically, a high dissimilarity ratio means that learning a plurality of targeted question sentences has not progressed.

Therefore, according to the above-described configuration, in addition to the effect obtained by the information processing apparatus 1, it is possible to obtain an index indicating a degree of progress in learning a plurality of targeted question sentences. The dissimilarity ratio can be used, for example, to determine whether to terminate the update of the language model 111A.

Note that, instead of calculating the dissimilarity ratio, the ratio calculation unit 106A may calculate a similarity ratio that is a ratio of pairs each including a first answer sentence and a second answer sentence whose contents are similar to each other with respect to the all the plurality of pairs of first answer sentences and second answer sentences. Similarly to the dissimilarity ratio, the similarity ratio is an index indicating a degree of progress in learning a plurality of targeted question sentences. A high similarity ratio means that learning a plurality of targeted question sentences has progressed. Furthermore, the ratio calculation unit 106A may calculate both the dissimilarity ratio and the similarity ratio.

The presentation unit 107A may present the dissimilarity ratio calculated by the ratio calculation unit 106A to the user. As a result, in addition to the effect obtained by the information processing apparatus 1, it is possible to enable the user to recognize a degree of progress in learning a plurality of targeted question sentences. Note that, in a case where the ratio calculation unit 106A calculates a similarity ratio instead of the dissimilarity ratio, the presentation unit 107A may present the similarity ratio. Furthermore, in a case where the ratio calculation unit 106A calculates both the dissimilarity ratio and the similarity ratio, the presentation unit 107A may present both the similarity ratio and the dissimilarity ratio.

Furthermore, if the dissimilarity ratio is equal to or greater than a predetermined threshold value or if the similarity ratio is equal to or smaller than a predetermined threshold value, the learning unit 105A may update the language model 111A by machine learning using the training data 112A in which a second answer sentence corresponding to each of the plurality of question sentences is associated with the question sentence. As a result, in addition to the effect obtained by the information processing apparatus 1, in a case where the degree of progress in learning the plurality of targeted question sentences is insufficient, it is possible to automatically update the language model 111A to resolve the insufficiency.

Here, the learning unit 105A may update the language model 111A by machine learning using, as the training data 112A, a pair of which a content of a second answer sentence is determined to be dissimilar to a content of a first answer sentence among the pairs of question sentences and second answer sentences corresponding to the question sentences. As a result, in addition to the effect obtained by the information processing apparatus 1, it is possible to achieve an efficient update by focusing on questions for which appropriate first answer sentences conforming to the target document have not been provided.

For example, the learning unit 105A may update the language model 111A using a plurality of pieces of training data 112A stored in the storage unit 11A. Then, the learning unit 105A may update the language model 111A again using training data 112A in which contents of second answer sentences are determined to be dissimilar to contents of first answer sentences among the training data 112A used for the update. As a result, it is possible to compensate for any insufficient learning in the first update by the second update.

### Regarding Dissimilarity Ratio/Similarity Ratio Between First Answer Sentence and Third Answer Sentence

As described above, the first answer sentence is an answer sentence to the question sentence about the content of the target document. The first answer sentence may be generated by the language model 111A after being updated using predetermined training data. In this case, the generation control unit 101A may generate an answer sentence by inputting the question sentence to the language model 111A before being updated using the training data (hereinafter, referred to as a third answer sentence). Then, the determination unit 102A may determine a similarity between the first answer sentence and the third answer sentence.

As a result, in addition to the effect obtained by the information processing apparatus 1, it is possible to obtain a further index for automatically determining the progress of the language model 111A in learning the target document. Note that the result of the determination of the similarity between the first answer sentence and the third answer sentence may be used as an index indicating the progress in learning as it is, or at least one of a dissimilarity ratio or a similarity ratio calculated based on the result of the determination of the similarity may be used as an index indicating the progress in learning as will be described below.

In a case where at least one of a dissimilarity ratio or a similarity ratio is calculated, the generation control unit 101A generates a plurality of first answer sentences and a plurality of third answer sentences using a plurality of question sentences, thereby obtaining a plurality of pairs each including a first answer sentence and a third answer sentence corresponding to the same question sentence. Furthermore, the determination unit 102A determines a similarity for each of the plurality of pairs. Then, the ratio calculation unit 106A calculates a dissimilarity ratio, which is a ratio of pairs each including a first answer sentence and a third answer sentence whose contents are dissimilar to each other with respect to all of the plurality of pairs of first answer sentences and third answer sentences, based on the result of the determination of the similarity for each pair including a first answer sentence and a third answer sentence corresponding to the same question sentence.

The method of calculating the dissimilarity ratio between the first answer sentence and the third answer sentence is similar to the method of calculating the dissimilarity ratio between the first answer sentence and the second answer sentence. In addition, the similarity ratio may be calculated instead of the dissimilarity ratio, or both the similarity ratio and the dissimilarity ratio may be calculated, similarly to the case where a pair of a first answer sentence and a second answer sentence is a target. In the following description, in order to distinguish the dissimilarity ratio between the first answer sentence and the second answer sentence and the dissimilarity ratio between the first answer sentence and the third answer sentence, the former will be referred to as a “first dissimilarity ratio” and the latter will be referred to as a “second dissimilarity ratio”. The same applies to the similarity ratios.

The first dissimilarity ratio indicates a degree of progress in learning a plurality of targeted question sentences (included in the training data 112A used for updating the language model 111A), more accurately, a ratio at which answer sentences conforming to the content of the target document can be generated in response to the question sentences. As described above, a high first dissimilarity ratio means that learning has not progressed. Therefore, for example, the update control unit 108A may terminate the update of the language model 111A if the first dissimilarity ratio calculated after the update of the language model 111A is smaller than a predetermined threshold value, and continue the update of the language model 111A if the first dissimilarity ratio is equal to or greater than the predetermined threshold value.

On the other hand, the second dissimilarity ratio indicates a ratio of answer sentences whose contents have been changed after learning among the plurality of pieces of training data used by the language model 111A for learning. It can also be said that the second dissimilarity ratio is an index indicating a degree to which the language model 111A before learning has forgotten existing knowledge that was used to generate an answer (third answer). The fact that the contents of the answer sentences have changed after learning means that the existing knowledge has been forgotten and new knowledge has been acquired, and the learning effect has been achieved. Therefore, the second dissimilarity ratio can also be used as an index indicating the progress in learning.

A high second dissimilarity ratio means that learning is progressing. Therefore, for example, the update control unit 108A may terminate the update of the language model 111A if the second dissimilarity ratio calculated after the update of the language model 111A is equal to or greater than a predetermined threshold value, and continue the update of the language model 111A if the second dissimilarity ratio is smaller than the predetermined threshold value.

Note that if a content of an answer sentence generated by the language model 111A after learning, that is, a first answer sentence, is dissimilar to the corresponding third answer sentence, this contributes to increasing the second dissimilarity ratio regardless of whether the first answer sentence has a content conforming to the content of the target document. Therefore, the second dissimilarity ratio tends to be larger than the first dissimilarity ratio. Therefore, in a case where it is determined whether to terminate the update of the language model 111A based on the second dissimilarity ratio, the update of the language model 111A is terminated earlier than in a case where it is determined whether to terminate the update of the language model 111A based on the first dissimilarity ratio. Which one of the first dissimilarity ratio and the second dissimilarity ratio is used to determine whether to terminate the update of the language model 111A is arbitrary, and which one is used may be determined according to the accuracy required for the language model 111A, the time allowed for learning, and the like.

Furthermore, it may be determined whether to terminate the update of the language model 111A based on both the first dissimilarity ratio and the second dissimilarity ratio. For example, the update control unit 108A may terminate the update of the language model 111A on condition that the first dissimilarity ratio is smaller than the first threshold value and the second dissimilarity ratio is equal to or greater than the second threshold value. The same applies to a case where the first and second similarity ratios are used instead of the first and second dissimilarity ratios.

### Regarding Amplification of Training Data 112A

The generation control unit 101A may amplify the training data 112A used for updating the language model 111A. More specifically, the generation control unit 101A may cause the language model 111A to generate a question sentence similar to a question sentence for which the content of the corresponding second answer sentence is determined to be dissimilar to the content of the first answer sentence among the plurality of question sentences.

For example, the generation control unit 101A may extract data including a second answer sentence for which the determination result of the determination unit 102A indicates dissimilarity from among the plurality of pieces of training data 112A stored in the storage unit 11A. Then, the generation control unit 101A may generate a prompt including a question sentence (a question sentence considered to be insufficiently learned) included in the extracted training data 112A and instructing the language model 111A to generate a question sentence similar to the question sentence included in the extracted training data 112A, and input the generated prompt to the language model 111A. As a result, the generation control unit 101A can cause the language model 111A to generate a question sentence for which the content of the corresponding second answer sentence is determined to be dissimilar to the content of the first answer sentence, that is, a question sentence similar to the question sentence considered to be insufficiently learned.

Then, the generation control unit 101A may input the generated question sentence and at least a part of the target document to the language model 111A to generate an answer sentence conforming to the content of the target document, and generate a new pair of the question sentence and the answer sentence. As a result, the learning unit 105A can update the language model 111A by machine learning using the new pair of the question sentence and the answer sentence as the training data 112A.

According to the above-described configuration, in addition to the effect obtained by the information processing apparatus 1, it is possible to increase accuracy in generating answer sentences to not only question sentences which the degree of progress in learning is insufficient but also question sentences similar to such question sentences.

### Regarding Generation of Question Sentence and Answer Sentence

As described above, the generation control unit 101A can cause the language model 111A to generate a question sentence by inputting, to the language model 111A, a prompt including a target document and a sentence instructing the language model 111A to generate a question sentence about the content of the target document.

For example, if one question sentence about the content of the target document is generated, the generation control unit 101A may use a prompt including a template sentence such as “Please read the document and create one question”. The generation control unit 101A can also generate a plurality of question sentences by using a prompt in which “one” of the template sentence is changed to another number.

The above-described prompt may include a sentence indicating various constraint conditions. As a result, it is easy to generate a question sentence having a desired content. Examples of the above-described constraint conditions include generating a question related to the content of the target document, generating a question that can be answered surely by reading the target document, using specific words, and making a question clear so as not to be misleading even for people who have not seen the target document. In addition, for example, the prompt may also include a sentence instructing the language model to generate a question that can be answered by YES or NO, generate a question asking a definition of a term described in the target document, generate a question asking a method described in the target document, or the like. Furthermore, if a question sentence for one target document is repeatedly generated, the generation control unit 101A may use a prompt including a sentence instructing the language model to generate a question from a different viewpoint so as not to have a content similar to those of existing questions, together with the previously generated question sentences and target document.

Furthermore, if the generation control unit 101A causes the language model 111A to generate an answer sentence to a question sentence, the generation control unit 101A is only required to input, to the language model 111A, a prompt including a sentence instructing the language model 111A to generate an answer conceivable from the target document for the question, together with the question sentence and the target document. As a result, it is possible to cause the language model 111A to generate an answer sentence based on the content of the target document.

The generation control unit 101A can also generate a pair of a question sentence and an answer sentence. In this case, the generation control unit 101A may use a prompt including the target document and instructing the language model to generate a question sentence related to the content of the target document and an answer sentence to the question sentence. As a result, the generation control unit 101A can generate a pair of a question sentence and an answer sentence (a second answer sentence), that is, training data 112A, with one prompt.

### Regarding Determination of Similarity

As described above, the determination unit 102A determines a similarity using the language model 111A. Specifically, the determination unit 102A determines a similarity by inputting, to the language model 111A, a prompt including a plurality of question sentences between which a similarity is to be determined and a sentence instructing the language model 111A to output a similarity between the question sentences.

If it is determined whether a question sentence to be determined is similar to one or a plurality of previously generated question sentences, the determination unit 102A may use a prompt including a sentence such as “Please answer “YES” if there is a question sentence similar to the target question sentence among the previously generated question sentences, or please answer “NO” if not ”. In addition, this prompt may also include a sentence instructing the language model to output a similar question sentence, if any, among the previously generated question sentences. As a result, the user can confirm the validity of the result of the determination made by the determination unit 102A.

In addition, if it is determined a degree to which the question sentence to be determined is similar to one or a plurality of previously generated question sentences, the determination unit 102A may use a prompt to instruct the language model to return the similarity as a numerical value. For example, the determination unit 102A outputs may use a prompt including sentences such as “Please answer the degree to which the targeted question sentence is similar to the previously generated question sentences as a numerical value ranging from 0 to 1. Please answer for each of the previously generated question sentences. Note that the closer the numerical value is to 1, the higher the degree of similarity.”.

Furthermore, the determination unit 102A may determine a similarity in consideration of the answer sentence to the question sentence. In this case, the determination unit 102A is only required to input, to the language model 111A, a prompt including a plurality of pairs of question sentences and answer sentences between which similarities are to be determined and a sentence instructing the language model 111A to output a similarity for each of the pairs.

Furthermore, the determination unit 102A may use a prompt including a sentence indicating a purpose, context, or background of determining the similarity, or an entity that determines the similarity. As a result, it is possible to increase accuracy in determining the similarity. For example, the determination unit 102A may use a prompt including a sentence such as “You are an assistant who determines whether there is a question sentence similar to the targeted question sentence among the previously generated question sentences.”.

The determination unit 102A can also determine a similarity between the first answer sentence and the second answer sentence using the language model 111A. As a result, in addition to the effect obtained by the information processing apparatus 1, it is possible to improve accuracy in determining the similarity as the language model 111A is updated.

Note that, in a case where a similarity between the first answer sentence and the second answer sentence is determined using the language model 111A, the determination unit 102A is only required to generate a prompt including a sentence including the first answer sentence and the second answer sentence and instructing the language model 111A to output a similarity between the first and second answer sentences, and input the generated prompt to the language model 111A. Similarly, the determination unit 102A can determine a similarity between the first answer sentence and the third answer sentence. Similarly to the case where the similarity between question sentences is determined, the result of the determination of the similarity may indicate whether the answer sentences are similar to each other, or may indicate a degree to which the answer sentences are similar to each other.

### Flow of Processing: Overall

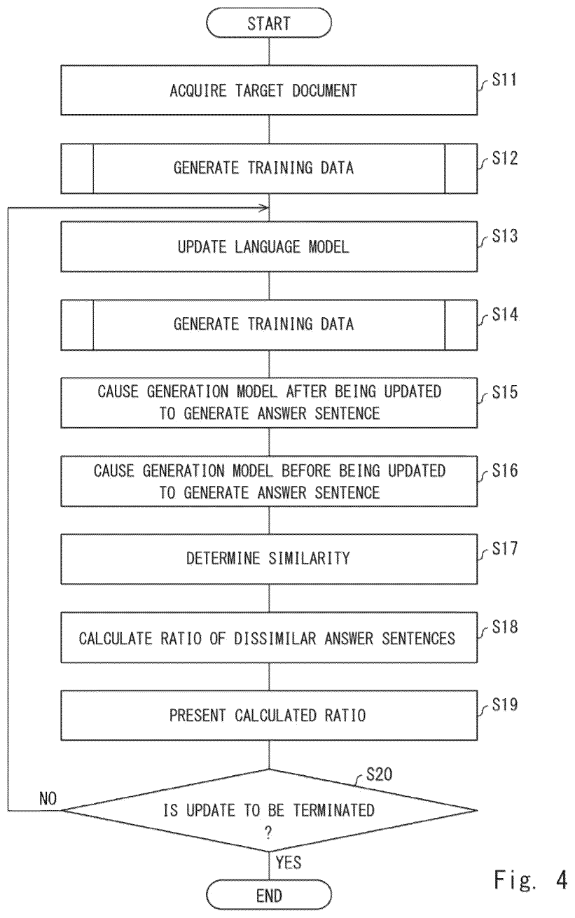

A flow of processing executed by the information processing apparatus 1A will be described with reference to FIG. 4. FIG. 4 is a flowchart illustrating an example of processing executed by the information processing apparatus 1A. The flowchart of FIG. 4 includes each step of the determination method according to the present example embodiment.

In S11, the data acquisition unit 103A acquires a target document. The method of acquiring the target document is not particularly limited. For example, the data acquisition unit 103A may acquire the target document input via the input unit 13A, or may acquire the target document stored in another apparatus via the communication unit 12A. Furthermore, for example, the data acquisition unit 103A may acquire voice data of an oral explanation, and acquire a text generated by performing voice recognition on the voice data as the target document.

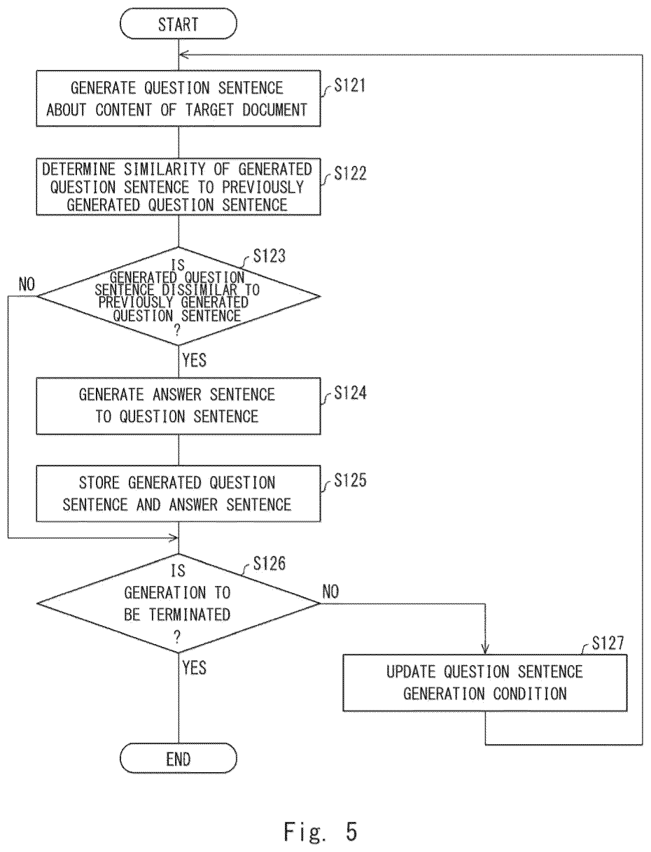

In S12, a plurality of pieces of training data 112A are generated using the target document acquired in S11. The processing of generating the training data 112A will be described in detail later with reference to FIG. 5.

In S13, the learning unit 105A updates the language model 111A by performing machine learning using the training data 112A generated in S12. Here, the learning unit 105A also leaves the language model 111A before being updated without deleting it.

In S14, similarly to S12, a plurality of pieces of training data 112A are generated using the target document acquired in S11. S12 and S14 are different in whether the language model 111A used for generating the training data 112A is one before being updated in S13 or one after being updated in S13. In addition, the number of pieces of training data 112A to be generated and generation-related conditions may be different between S12 and S14.

In S15 (generation control processing), the generation control unit 101A inputs a question sentence (included in the training data generated in S14) about the content of the target document acquired in S11 to the language model 111A updated in S13 to generate a first answer sentence. This processing is performed for each of the question sentences included in the plurality of pieces of training data 112A generated in S14. Note that the answer sentence associated with the question sentence in the training data 112A is an answer sentence generated by causing the language model 111A to refer to at least a part of the target document, that is, a second answer sentence. Furthermore, the processing of S15 may be performed for each of the first question sentences included in the plurality of pieces of training data 112A generated in S12.

In S16, the generation control unit 101A inputs the question sentence (included in the training data generated in S14) about the content of the target document acquired in S11 to the language model 111A before being updated in S13 to generate a third answer sentence. This processing is performed for each of the question sentences included in the plurality of pieces of training data 112A generated in S14. The processing in S16 is different from the processing S15 in whether the language model used for generating the answer sentence is one before being updated in S13 or one after being updated in S13. Note that the processing of S16 may be performed earlier than the processing of S15, or may be performed in parallel with the processing of S15.

In S17 (determination processing), the determination unit 102A determines a similarity between the second answer sentence (included in the training data generated in S14) generated by causing the language model 111A to refer to at least a part of the target document and the first answer sentence generated in S15. This determination is made for each of the second answer sentences included in the plurality of pieces of training data 112A generated in S14. Note that the first answer sentence and the second answer sentence corresponding to the same question sentence are targets for determining the similarity.

In addition, in S17, the determination unit 102A determines the similarity between the third answer sentence generated in S16 and the first answer sentence generated in S15. In this determination as well, the first answer sentence and the third answer sentence corresponding to the same question sentence are targets for determining the similarity. This determination is made for each of the plurality of first answer sentences generated in S15. Note that it is not essential to determine the similarity between the first answer sentence and the third answer sentence, and it may be omitted. If the determination of the similarity between the first answer sentence and the third answer sentence is omitted, the processing in S16 is also omitted.

In S18, the ratio calculation unit 106A calculates a ratio of pairs each including a first answer sentence and a second answer sentence whose contents are dissimilar to each other with respect to all the plurality of pairs of first answer sentences and second answer sentences, that is, a first dissimilarity ratio, based on the determination result of S17. For example, in a case where the determination result of S17 indicates whether the content of the first answer sentence and the content of the second answer sentence are similar or dissimilar to each other, the ratio calculation unit 106A may set a value obtained by dividing the number of pairs for which the content of the first answer sentence and the content of the second answer sentence are dissimilar to each other by the total number of pairs as the first dissimilarity ratio. Furthermore, in a case where the determination result of S17 is a numerical value indicating a similarity, the ratio calculation unit 106A may calculate the first dissimilarity ratio by regarding a pair having a similarity equal to or greater than a predetermined threshold value as being similar and regarding a pair having a similarity smaller than the predetermined threshold value as being dissimilar.

In addition, in S18, the ratio calculation unit 106A calculates a ratio of pairs each including a first answer sentence and a third answer sentence whose contents are dissimilar to each other with respect to all the plurality of pairs of first answer sentences and third answer sentences, that is, a second dissimilarity ratio, based on the determination result of S17. The method of calculating the second dissimilarity ratio is similar to the method of calculating the first dissimilarity ratio. Note that, if the determination of the similarity between the first answer sentence and the third answer sentence is omitted, the calculation of the second dissimilarity ratio is also omitted.

In S19, the presentation unit 107A presents the ratios calculated in S18, that is, the first dissimilarity ratio and the second dissimilarity ratio, to the user by causing the output unit 14A to output the ratios.

In S20, the update control unit 108A determines whether to terminate the update of the language model 111A. If YES is determined in S20, the processing of FIG. 4 ends. The condition for terminating the update (hereinafter, referred to as the termination condition) may be determined in advance. For example, the termination condition may be that the first dissimilarity ratio is smaller than a predetermined threshold value. Furthermore, for example, the termination condition may be that the second dissimilarity ratio is equal to or greater than a predetermined threshold value, or the termination condition may be that the first dissimilarity ratio is smaller than the predetermined threshold value and the second dissimilarity ratio is equal to or greater than the predetermined threshold value.

Furthermore, for example, the termination condition may be that the user performs a predetermined operation for terminating the update. In this case, the user may determine whether to terminate the update with reference to the first dissimilarity ratio and the second dissimilarity ratio presented in S19.

If NO is determined in S20, the processing returns to S13, and the language model 111A is updated. In S13 to which the processing has transitioned from S20, the learning unit 105A updates the language model 111A using the training data 112A generated in S14. At this time, the learning unit 105A may extract training data 112A including a second answer sentence determined to be dissimilar as a determination result of S17 from the training data 112A generated in S14, and update the language model 111A using the extracted training data 112A.

Note that, after the processing of S17, the presentation unit 107A may present the determination result of S17 to the user. As a result, it is possible to enable the user to recognize a similarity between the second answer sentence included in the training data 112A used for updating the language model 111A and the first answer sentence. In this case, the user can determine whether to terminate the update of the language model 111A based on the presented similarity, S18 and S19 may be omitted, and it may be determined whether to terminate the update according to the operation of the user in S20. Furthermore, at the time of presenting the determination result of S17, the presentation unit 107A preferably also presents a question sentence corresponding to each determination result. As a result, it is possible to enable the user to recognize what question sentence is insufficiently learned by the language model 111A.

### Flow of Processing: Generation of Training Data 112A

The processing of S12 in FIG. 4 will be described in detail with reference to FIG. 5. FIG. 5 is a flowchart illustrating the processing of S12 in FIG. 4. As described above, the processing of S14 in FIG. 4 is similar to the processing of S12, and training data 112A is also generated in S14 of FIG. 4 according to the flow illustrated in FIG. 5.

In S121, the set generation unit 104A instructs the generation control unit 101A to generate a question sentence. Then, the generation control unit 101A causes the language model 111A to generate a question sentence according to this instruction. Specifically, the generation control unit 101A causes the language model 111A to generate a question sentence by inputting, to the language model 111A, a prompt including a sentence instructing the language model 111A to generate a question sentence about the content of the target document together with the target document acquired in S11 of FIG. 4. If the question sentence generated in S121 is obviously inappropriate (for example, if the question sentence is not established as a sentence), the set generation unit 104A may discard the question sentence and instruct the generation control unit 101A to generate a new question sentence.

In S122, the determination unit 102A determines a similarity between the question sentence generated in S121 and the question sentence generated earlier than that question sentence. The flow of FIG. 5 is repeatedly performed until YES is determined in S126. In the first loop, the processing of S122 is omitted because there is no previously generated question sentence. Then, in the second loop, a similarity between the question sentence generated in S121 in the first loop and a question sentence generated in S121 in the second loop is determined. Furthermore, in the third loop, a similarity between the question sentence generated in S121 in each of the first and second loops and a question sentence generated in S121 in the third loop is determined. The fourth and subsequent loops are similar to the third loop.

In S123, the set generation unit 104A determines whether the content of the question sentence generated in S121 is dissimilar to the content of the question sentence generated earlier than that question sentence based on the determination result in S122. For example, the set generation unit 104A may determine that the question sentences are dissimilar if the similarity determined by the determination unit 102A in S122 is equal to or smaller than a predetermined threshold value. In addition, if the determination unit 102A determines whether the question sentences are similar or dissimilar in S122, the set generation unit 104A may use the determination result in S122 as it is as a determination result in S123.

Note that, in the third and subsequent loops, the set generation unit 104A determines whether the last generated question sentence is similar to each of the plurality of question sentences generated before the last generated question sentence, and sets the determination result in S123 to YES if all the determination results indicate that the question sentences are dissimilar. On the other hand, if at least one determination result indicates that the question sentences are similar, the set generation unit 104A sets the determination result in S123 to NO. In addition, the set generation unit 104A determines YES in S123 in the first loop.

If YES is determined in S123, the processing proceeds to S124. In S124, the generation control unit 101A causes the language model 111A to generate an answer sentence to the question sentence generated in S121 (the question sentence determined to be dissimilar to any of the previously generated question sentences). Specifically, the generation control unit 101A causes the language model 111A to generate an answer sentence by inputting, to the language model 111A, a question sentence, a target document, and a prompt instructing the language model 111A to generate an answer sentence to the question sentence based on the content of the target document. The answer sentence generated in S124 is the second answer sentence described above. If the answer sentence generated in S124 is obviously inappropriate (for example, if the answer sentence is not established as a sentence), the set generation unit 104A may instruct the generation control unit 101A to regenerate an answer sentence.

In S125, the set generation unit 104A stores the question sentence generated in S121 and the answer sentence (generated in S124) to the question sentence in association with each other as training data 112A in the storage unit 11A. Furthermore, the set generation unit 104A may present the training data 112A to the user by causing the output unit 14A to output the training data 112A. After completion of S125, the processing proceeds to S126.

If NO is determined in S123, the processing proceeds to S126 without performing the processing of S124 and S125. That is, for the question sentence for which NO is determined in S123, an answer sentence is not generated and is not stored in the storage unit 11A. As a result, a set including pairs of question sentences whose contents are dissimilar and answer sentences corresponding thereto as elements is generated and stored as the training data 112A.

In S126, the set generation unit 104A determines whether to terminate the generation of the training data 112A. If NO is determined in S126, the set generation unit 104A instructs the generation control unit 101A to change the question sentence generation condition and generate a question sentence, and accordingly, the processing proceeds to S127. On the other hand, if YES is determined in S126, the processing of FIG. 5 ends.

The determination condition in S126 may be appropriately determined. For example, the set generation unit 104A may determine to terminate the generation of the training data 112A if the number of repetitions of the processing of S121 to S126 has reached a predetermined upper limit number. The upper limit number may be appropriately set according to the number of pieces of training data 112A to be generated, the volume of the target document, and the like. Furthermore, for example, the set generation unit 104A may determine to terminate the generation of the training data 112A if the number of pieces of stored training data 112A has reached a predetermined upper limit number. In this case, the number of pieces of training data 112A to be generated may be set to the upper limit number.

In addition, as the processing from S121 to S126 is repeated, the total number of pieces of training data 112A stored in S125 increases, and thus, the ratio of question sentences determined to be dissimilar in S122 decreases. Then, if the training data 112A stored in S125 covers the entire target document, the ratio of question sentences determined to be dissimilar in S122 becomes 0 or a value close to 0.

Therefore, for example, the set generation unit 104A may determine to terminate the generation of the training data 112A if the ratio of question sentences dissimilar to any of the question sentences generated before the processing from S121 to S126 is repeated a predetermined number of times with respect to all of the plurality of latest question sentences generated by repeating the processing from S121 to S126 the predetermined number of times is equal to or smaller than a predetermined threshold value. As a result, it is possible to terminate the generation of the training data 112A at an appropriate timing and generating a set of training data 112A covering the entire target document without bias.

For example, in a case where the predetermined number of times is set to 5 times and the threshold value is set to ⅕, the set generation unit 104A terminates the generation of the training data 112A if the number of question sentences determined to be dissimilar in S122 is 0 or 1 among the most recently generated five question sentences. The threshold value may be set to zero. In this case, if all of the predetermined number of question sentences generated most recently are determined to be dissimilar in S122, in other words, if the determination result in S122 consecutively indicates that question sentences are dissimilar a predetermined number of times, the set generation unit 104A terminates the generation of the training data 112A.

In S127, the generation control unit 101A changes the question sentence generation condition. After S127, the processing returns to S121, and the generation control unit 101A applies the changed generation condition to cause the language model 111A to generate a new question sentence.

Note that the generation condition to be changed in S127 is arbitrary and may be determined in advance. For example, the generation control unit 101A may change the value of the randomness parameter (for example, temperature parameter) in the language model 111A such that a greater variety of question sentences are generated. The randomness parameter is a hyperparameter for controlling the variety of options in the language model 111A. By adjusting the randomness parameter, it is possible to cause the language model 111A to generate a greater variety of question sentences.

Furthermore, in S127, the generation control unit 101A may change the prompt to be input to the language model 111A. In this case, a plurality of types of prompts may be prepared in advance. In addition, a plurality of patterns of prompt components may be prepared. In this case, the generation control unit 101A can change the generation condition by changing the combination of these components.

Note that it is not always necessary to change the question sentence generation condition every time NO is determined in S126. For example, the question sentence generation condition may be changed every time the cumulative number of times NO is determined in S126 reaches a predetermined number.

Furthermore, the training data 112A may be generated for each of the chunks into which the target document is divided. The chunks may be set in any manner, and for example, the user may set each chunk. Furthermore, breaks (for example, content breaks such as chapters, sections, or paragraphs, or mechanical breaks such as pages) in the target document may be detected, and the chunks may be automatically set according to the breaks. In addition, the chunks can be automatically set such that the number of characters contained in one chunk becomes a predetermined value.

The processing in the case where the training data 112A is generated for each chunk is performed by replacing the “target document” described above with reference to FIG. 5 with the “chunk of the target document”. Then, in a case where the training data 112A is generated for each chunk, the processing of FIG. 5 is performed for each of the plurality of chunks. Furthermore, in a case where the training data 112A is generated for each chunk, the answer sentence included in the generated training data, that is, the second answer sentence, is generated by referring to a part of the target document (a part of the chunk used for generating the second answer sentence).

Note that the above-described method of generating the training data 112A is merely an example. For example, in S121, a pair of a question sentence and an answer sentence (second answer sentence) may be generated by using a prompt including at least a part of the target document and instructing the language model to generate a question sentence and an answer sentence. In this case, the processing of S124 is omitted.

Furthermore, the generation control unit 101A may generate a plurality of question sentences at the beginning. In this case, the set generation unit 104A may generate a set of question sentences by extracting some of the plurality of question sentences generated under the control of the generation control unit 101A so that the ratio of question sentences dissimilar to the other question sentences with respect to the plurality of question sentences is equal to or greater than a predetermined lower limit value. Even in a case where such a configuration is adopted, a set of questions covering the entire target document can be generated.

Furthermore, if the ratio of question sentences dissimilar to the other question sentences with respect to the plurality of question sentences generated under the control of the generation control unit 101A is greater than a predetermined upper limit value, the set generation unit 104A may generate a set of question sentences by repeating processing of causing the generation control unit 101A to generate a new question sentence until the ratio becomes equal to or smaller than the upper limit value. Even in a case where such a configuration is adopted, a set of questions covering the entire target document can be generated.

Note that, by generating the training data 112A for each chunk, the coverage of the target document can be ensured. In this case, the set generation unit 104A may be omitted, and a predetermined number of pieces of training data 112A may be generated for each chunk.

### Example of Implementation by Software

Some or all of the functions of the information processing apparatus 1 or 1A may be implemented by hardware such as an integrated circuit (IC chip) or may be implemented by software.

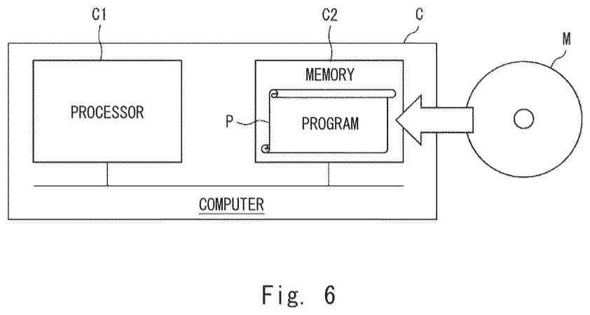

In the latter case, the information processing apparatuses 1 or 1A is implemented, for example, by a computer that executes a command of a program that is software for realizing each function. An example of such a computer (hereinafter, referred to as a computer C) is illustrated in FIG. 6. FIG. 6 is a block diagram illustrating a hardware configuration of the computer C that functions as the information processing apparatus 1 or 1A.

The computer C includes at least one processor C1 and at least one memory C2. A program (determination program) P for causing the computer C to operate as the information processing apparatus 1 or 1A is recorded in the memory C2. In the computer C, the processor C1 reads and executes the program P from the memory C2, thereby implementing each function of the information processing apparatus 1 or 1A.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and for temporarily storing various types of data. Furthermore, the computer C may further include a communication interface for transmitting and receiving data to and from other apparatuses. The computer C may further include an input/output interface for connecting input/output apparatuses such as a keyboard, a mouse, a display, and a printer.

A (The) program P can be stored and provided to the computer C using any type of non-transitory computer readable media M. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), cards, programmable logic circuits, and semiconductor memories (such as mask ROM, PROM (programmable ROM), EPROM (erasable PROM), flash ROM, RAM (random access memory), etc.). The program may be provided to the computer C using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Furthermore, each of the above-described functions of the information processing apparatus 1 or 1A may be implemented by a single processor provided in a single computer, may be implemented by a plurality of processors provided in a single computer in cooperation with each other, or may be implemented by a plurality of processors provided in a plurality of computers, respectively, in cooperation with each other. Furthermore, the program for causing the information processing apparatus 1 or 1A to implement each of the above-described functions may be stored in a single memory provided in a single computer, may be stored in a distributed manner in a plurality of memories provided in a single computer, or may be stored in a distributed manner in a plurality of memories provided in a plurality of computers, respectively.

### Supplementary Notes

The present disclosure includes the techniques described in the following supplementary notes. However, the present disclosure is not limited to the techniques described in the following supplementary notes, and various modifications can be made within the scope set forth in the claims.

### Supplementary Note A

### Supplementary Note A1

An information processing apparatus including: a generation control means for inputting a question sentence about a content of a targeted document to a language model generated by machine learning to generate an answer sentence to a question about the content of the document to cause the language model to generate a first answer sentence; and a determination means for determining a similarity between a second answer sentence to the question sentence, the second answer sentence being generated by causing the language model to refer to at least a part of the document, and the first answer sentence.

### Supplementary Note A2

The information processing apparatus according to supplementary note Al, in which the generation control means causes the language model to generate the first answer sentence and the second answer sentence for each of a plurality of question sentences, the determination means determines a similarity for each pair of the first answer sentence and the second answer sentence corresponding to a same question sentence, and the information processing apparatus further includes a ratio calculation means for calculating at least one of a dissimilarity ratio or a similarity ratio based on a result of the determination of the similarity, the dissimilarity ratio being a ratio of pairs each including the first answer sentence and the second answer sentence whose contents are dissimilar to each other with respect to all of a plurality of pairs each including the first answer sentence and the second answer sentence, and the similarity ratio being a ratio of pairs each including the first answer sentence and the second answer sentence whose contents are similar to each other with respect to all of the plurality of pairs each including the first answer sentence and the second answer sentence.

### Supplementary Note A3

The information processing apparatus according to supplementary note A2, further including a presentation means for presenting at least one of the dissimilarity ratio or the similarity ratio to a user.

### Supplementary Note A4

The information processing apparatus according to supplementary note A2 or A3, further including a learning means for updating the language model by machine learning using training data in which the second answer sentence corresponding to each of the plurality of question sentences is associated with the question sentence if the dissimilarity ratio is equal to or greater than a predetermined threshold value or the similarity ratio is equal to or smaller than a predetermined threshold value.

### Supplementary Note A5

The information processing apparatus according to supplementary note A4, in which the learning means updates the language model by machine learning using, as the training data, a pair in which a second answer sentence is determined to be dissimilar to a first answer sentence among pairs each including the question sentence and the second answer sentence corresponding to the question sentence.

### Supplementary Note A6

The information processing apparatus according to supplementary note A4 or A5, in which
the generation control means generates a new pair of a question sentence and an answer sentence by causing the language model to generate a question sentence similar to a question sentence for which a corresponding second answer sentence is determined to be dissimilar to a corresponding first answer sentence among the plurality of question sentences, and inputting the generated question sentence and at least a part of the document into the language model to causes the language model to generate an answer sentence corresponding to the content of the document, and
the learning means updates the language model by machine learning using the new pair of the question sentence and the answer sentence as the training data.

### Supplementary Note A7

The information processing apparatus according to any one of supplementary notes A1 to A6, in which the first answer sentence is generated by the language model after being updated using predetermined training data, and the determination means determines a similarity between a third answer sentence generated by inputting the question sentence to the language model before being updated using the training data and the first answer sentence.

### Supplementary Note A8

The information processing apparatus according to any one of supplementary notes A1 to A7, in which the determination means determines a similarity between the first answer sentence and the second answer sentence using the language model.

### Supplementary Note B

### Supplementary Note B1

A determination method including: generation control processing in which at least one processor inputs a question sentence about a content of a targeted document to a language model generated by machine learning to generate an answer sentence to a question about the content of the document to cause the language model to generate a first answer sentence; and determination processing in which the at least one processor determines a similarity between a second answer sentence to the question sentence, the second answer sentence being generated by causing the language model to refer to at least a part of the document, and the first answer sentence.

### Supplementary Note B2

The determination method according to supplementary note B1, in which in the generation control processing, the at least one processor causes the language model to generate the first answer sentence and the second answer sentence for each of a plurality of question sentences, in the determination processing, the at least one processor determines a similarity for each pair of the first answer sentence and the second answer sentence corresponding to a same question sentence, and the determination method further includes ratio calculation processing in which the at least one processor calculates at least one of a dissimilarity ratio or a similarity ratio based on a result of the determination of the similarity, the dissimilarity ratio being a ratio of pairs each including the first answer sentence and the second answer sentence whose contents are dissimilar to each other with respect to all of a plurality of pairs each including the first answer sentence and the second answer sentence, and the similarity ratio being a ratio of pairs each including the first answer sentence and the second answer sentence whose contents are similar to each other with respect to all of the plurality of pairs each including the first answer sentence and the second answer sentence.

### Supplementary Note B3

The determination method according to supplementary note B2, further including: presentation processing in which the at least one processor presents at least one of the dissimilarity ratio or the similarity ratio to a user.

### Supplementary Note B4

The determination method according to supplementary note B2 or B3, further including learning processing in which the at least one processor updates the language model by machine learning using training data in which the second answer sentence corresponding to each of the plurality of question sentences is associated with the question sentence if the dissimilarity ratio is equal to or greater than a predetermined threshold value or the similarity ratio is equal to or smaller than a predetermined threshold value.

### Supplementary Note B5

The determination method according to supplementary note B4, in which in the learning processing, the at least one processor updates the language model by machine learning using, as the training data, a pair in which a second answer sentence is determined to be dissimilar to a first answer sentence among pairs each including the question sentence and the second answer sentence corresponding to the question sentence.

### Supplementary Note B6

The determination method according to supplementary note B4 or B5, in which the at least one processor generates a new pair of a question sentence and an answer sentence by causing the language model to generate a question sentence similar to a question sentence for which a corresponding second answer sentence is determined to be dissimilar to a corresponding first answer sentence among the plurality of question sentences, and inputting the generated question sentence and at least a part of the document into the language model to causes the language model to generate an answer sentence corresponding to the content of the document, and in the learning processing, the at least one processor updates the language model by machine learning using the new pair of the question sentence and the answer sentence as the training data.

### Supplementary Note B7

The determination method according to any one of supplementary notes B1 to B6, in which the first answer sentence is generated by the language model after being updated using predetermined training data, and the at least one processor determines a similarity between a third answer sentence generated by inputting the question sentence to the language model before being updated using the training data and the first answer sentence.

### Supplementary Note B8

The determination method according to any one of supplementary notes B1 to B7, in which in the determination processing, a similarity between the first answer sentence and the second answer sentence is determined using the language model.

### Supplementary Note C

### Supplementary Note C1

A determination program causing a computer to function as: a generation control means for inputting a question sentence about a content of a targeted document to a language model generated by machine learning to generate an answer sentence to a question about the content of the document to cause the language model to generate a first answer sentence; and a determination means for determining a similarity between a second answer sentence to the question sentence, the second answer sentence being generated by causing the language model to refer to at least a part of the document, and the first answer sentence.

### Supplementary Note C2

The determination program according to supplementary note C1, in which the generation control means causes the language model to generate the first answer sentence and the second answer sentence for each of a plurality of question sentences, the determination means determines a similarity for each pair of the first answer sentence and the second answer sentence corresponding to a same question sentence, and the determination program further causes the computer to function as a ratio calculation means for calculating at least one of a dissimilarity ratio or a similarity ratio based on a result of the determination of the similarity, the dissimilarity ratio being a ratio of pairs each including the first answer sentence and the second answer sentence whose contents are dissimilar to each other with respect to all of a plurality of pairs each including the first answer sentence and the second answer sentence, and the similarity ratio being a ratio of pairs each including the first answer sentence and the second answer sentence whose contents are similar to each other with respect to all of the plurality of pairs each including the first answer sentence and the second answer sentence.

### Supplementary Note C3

The determination program according to supplementary note C2, further causing the computer to function as a presentation means for presenting at least one of the dissimilarity ratio or the similarity ratio to a user.

### Supplementary Note C4

The determination program according to supplementary note C2 or C3, further causing the computer to function as a learning means for updating the language model by machine learning using training data in which the second answer sentence corresponding to each of the plurality of question sentences is associated with the question sentence if the dissimilarity ratio is equal to or greater than a predetermined threshold value or the similarity ratio is equal to or smaller than a predetermined threshold value.

### Supplementary Note C5

The determination program according to supplementary note C4, in which the learning means updates the language model by machine learning using, as the training data, a pair in which a second answer sentence is determined to be dissimilar to a first answer sentence among pairs each including the question sentence and the second answer sentence corresponding to the question sentence.

### Supplementary Note C6

The determination program according to supplementary note C4 or C5, in which the generation control means generates a new pair of a question sentence and an answer sentence by causing the language model to generate a question sentence similar to a question sentence for which a corresponding second answer sentence is determined to be dissimilar to a corresponding first answer sentence among the plurality of question sentences, and inputting the generated question sentence and at least a part of the document into the language model to causes the language model to generate an answer sentence corresponding to the content of the document, and the learning means updates the language model by machine learning using the new pair of the question sentence and the answer sentence as the training data.

### Supplementary Note C7

The determination program according to any one of supplementary notes C1 to C6, in which the first answer sentence is generated by the language model after being updated using predetermined training data, and the determination means determines a similarity between a third answer sentence generated by inputting the question sentence to the language model before being updated using the training data and the first answer sentence.

### Supplementary Note C8

The determination program according to any one of supplementary notes C1 to C7, in which the determination means determines a similarity between the first answer sentence and the second answer sentence using the language model.

### Supplementary Note D

### Supplementary Note D1

An information processing apparatus including at least one processor, in which the at least one processor executes generation control processing of inputting a question sentence about a content of a targeted document to a language model generated by machine learning to generate an answer sentence to a question about the content of the document to cause the language model to generate a first answer sentence; and determination processing of determining a similarity between a second answer sentence to the question sentence, the second answer sentence being generated by causing the language model to refer to at least a part of the document, and the first answer sentence.

Note that the information processing apparatus may further include a memory. In addition, the memory may store a program for causing the at least one processor to execute each step of processing.

### Supplementary Note D2

The information processing apparatus according to supplementary note DI, in which the at least one processor causes the language model to generate the first answer sentence and the second answer sentence for each of a plurality of question sentences, in the determination processing, a similarity for each pair of the first answer sentence and the second answer sentence corresponding to a same question sentence is determined, and the at least one processor further executes ratio calculation processing of calculating at least one of a dissimilarity ratio or a similarity ratio based on a result of the determination of the similarity, the dissimilarity ratio being a ratio of pairs each including the first answer sentence and the second answer sentence whose contents are dissimilar to each other with respect to all of a plurality of pairs each including the first answer sentence and the second answer sentence, and the similarity ratio being a ratio of pairs each including the first answer sentence and the second answer sentence whose contents are similar to each other with respect to all of the plurality of pairs each including the first answer sentence and the second answer sentence.

### Supplementary Note D3

The information processing apparatus according to supplementary note D2, in which the at least one processor further executes presentation processing of presenting at least one of the dissimilarity ratio or the similarity ratio to a user.

### Supplementary Note D4

The information processing apparatus according to supplementary note D2 or D3, in which the at least one processor further executes learning processing of updating the language model by machine learning using training data in which the second answer sentence corresponding to each of the plurality of question sentences is associated with the question sentence if the dissimilarity ratio is equal to or greater than a predetermined threshold value or the similarity ratio is equal to or smaller than a predetermined threshold value.

### Supplementary Note D5

The information processing apparatus according to supplementary note D4, in which in the learning processing, the at least one processor updates the language model by machine learning using, as the training data, a pair in which a second answer sentence is determined to be dissimilar to a first answer sentence among pairs each including the question sentence and the second answer sentence corresponding to the question sentence.

### Supplementary Note D6

The information processing apparatus according to supplementary note D4 or D5, in which the at least one processor generates a new pair of a question sentence and an answer sentence by causing the language model to generate a question sentence similar to a question sentence for which a corresponding second answer sentence is determined to be dissimilar to a corresponding first answer sentence among the plurality of question sentences, and inputting the generated question sentence and at least a part of the document into the language model to causes the language model to generate an answer sentence corresponding to the content of the document, and in the learning processing, the at least one processor updates the language model by machine learning using the new pair of the question sentence and the answer sentence as the training data.

### Supplementary Note D7

The information processing apparatus according to any one of supplementary notes D1 to D6, in which the first answer sentence is generated by the language model after being updated using predetermined training data, and the at least one processor determines a similarity between a third answer sentence generated by inputting the question sentence to the language model before being updated using the training data and the first answer sentence.

### Supplementary Note D8

The information processing apparatus according to any one of supplementary notes D1 to D7, in which the determination means determines a similarity between the first answer sentence and the second answer sentence using the language model.

### Supplementary Note E

A non-transitory recording medium storing a determination program for causing a computer to execute: generation control processing of inputting a question sentence about a content of a targeted document to a language model generated by machine learning to generate an answer sentence to a question about the content of the document to cause the language model to generate a first answer sentence; and determination processing of determining a similarity between a second answer sentence to the question sentence, the second answer sentence being generated by causing the language model to refer to at least a part of the document, and the first answer sentence.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory configured to store instructions; and
at least one processor configured to execute the instructions,
wherein the at least one processor is configured to execute the instructions to:
input a question sentence about a content of a targeted document to a language model generated by machine learning to generate an answer sentence to a question about the content of the document to cause the language model to generate a first answer sentence; and
determine a similarity between a second answer sentence to the question sentence, the second answer sentence being generated by causing the language model to refer to at least a part of the document, and the first answer sentence.

2. The information processing apparatus according to claim 1, wherein the at least one processor is further configured to execute the instructions to:
cause the language model to generate the first answer sentence and the second answer sentence for each of a plurality of question sentences;
determine a similarity for each pair of the first answer sentence and the second answer sentence corresponding to a same question sentence; and
calculate at least one of a dissimilarity ratio or a similarity ratio based on a result of the determination of the similarity, the dissimilarity ratio being a ratio of pairs each including the first answer sentence and the second answer sentence whose contents are dissimilar to each other with respect to all of a plurality of pairs each including the first answer sentence and the second answer sentence, and the similarity ratio being a ratio of pairs each including the first answer sentence and the second answer sentence whose contents are similar to each other with respect to all of the plurality of pairs each including the first answer sentence and the second answer sentence.

3. The information processing apparatus according to claim 2, wherein the at least one processor is further configured to execute the instructions to present at least one of the dissimilarity ratio or the similarity ratio to a user.

4. The information processing apparatus according to claim 2, wherein the at least one processor is further configured to execute the instructions to update the language model by machine learning using training data in which the second answer sentence corresponding to each of the plurality of question sentences is associated with the question sentence if the dissimilarity ratio is equal to or greater than a predetermined threshold value or the similarity ratio is equal to or smaller than a predetermined threshold value.

5. The information processing apparatus according to claim 4, wherein the at least one processor is further configured to execute the instructions to update the language model by machine learning using, as the training data, a pair in which a second answer sentence is determined to be dissimilar to a first answer sentence among pairs each including the question sentence and the second answer sentence corresponding to the question sentence.

6. The information processing apparatus according to claim 4, wherein the at least one processor is further configured to execute the instructions to:
generate a new pair of a question sentence and an answer sentence by causing the language model to generate a question sentence similar to a question sentence for which a corresponding second answer sentence is determined to be dissimilar to a corresponding first answer sentence among the plurality of question sentences, and inputting the generated question sentence and at least a part of the document into the language model to causes the language model to generate an answer sentence corresponding to the content of the document; and
update the language model by machine learning using the new pair of the question sentence and the answer sentence as the training data.

7. The information processing apparatus according to claim 1, wherein
the first answer sentence is generated by the language model after being updated using predetermined training data, and
the at least one processor is further configured to execute the instructions to determine a similarity between a third answer sentence generated by inputting the question sentence to the language model before being updated using the training data and the first answer sentence.

8. The information processing apparatus according to claim 1, wherein the at least one processor is further configured to execute the instructions to determine a similarity between the first answer sentence and the second answer sentence using the language model.

9. A determination method executed by a computer, the determination method comprising:
inputting a question sentence about a content of a targeted document to a language model generated by machine learning to generate an answer sentence to a question about the content of the document to cause the language model to generate a first answer sentence; and
determining a similarity between a second answer sentence to the question sentence, the second answer sentence being generated by causing the language model to refer to at least a part of the document, and the first answer sentence.

10. A non-transitory computer-readable medium storing a program for causing a computer to execute:
inputting a question sentence about a content of a targeted document to a language model generated by machine learning to generate an answer sentence to a question about the content of the document to cause the language model to generate a first answer sentence; and
determining a similarity between a second answer sentence to the question sentence, the second answer sentence being generated by causing the language model to refer to at least a part of the document, and the first answer sentence.
